(19) United States
(12) Patent Application Publication
(10) Pub. No.: US 2019/0095136 A1
(43) Pub. Date: Mar. 28, 2019

(54) MEMORY CONTROL DEVICE, STORAGE DEVICE, AND INFORMATION PROCESSING SYSTEM

(71) Applicant: SONY CORPORATION, TOKYO (JP)

(72) Inventors: HIDEAKI OKUBO, SAITAMA (JP); KENICHI NAKANISHI, TOKYO (JP)

(21) Appl. No.: 16/086,833

(22) PCT Filed: Dec. 28, 2016
(86) PCT No.: PCT/JP2016/089110

§ 371 Date: Sep. 20, 2018

(30) Foreign Application Priority Data
Mar. 29, 2016 (JP) 2016-066030

(51) Int. Cl. G06F 3/06; G06F 12/02; G06F 13/16; G06F 13/18; G06F 13/24

(52) U.S. Cl. CPC G06F 3/0659; G06F 3/0646; G06F 3/061; G06F 13/24; G06F 12/0246; G06F 13/1689; G06F 13/18; G06F 3/0683

(57) ABSTRACT

To perform both writing and reading at a high speed by utilizing a first memory and a second memory that has a lower writing speed and a higher reading speed than the first memory. A writing unit writes writing data related to a writing command in a first memory when the writing command is executed. A transfer unit transfers the writing data from the first memory to a second memory at a predetermined timing. A reading unit performs reading of reading data from the second memory with higher priority than from the first memory when a reading command is executed.

### TECHNICAL FIELD

The present technology relates to a storage device. Specifically, the present technology relates to a memory control device, a storage device, and an information processing system that control a plurality of types of memories with different performances, a processing method performed therein, and a program that causes a computer to execute the method.

### BACKGROUND ART

In recent years, a system configuration that takes advantage of properties of respective memories has been considered for a storage system on the assumption of a plurality of types of memories with different performances. For example, a system that uses a non-volatile random access memory (NVRAM) with a short access time and a flash memory with a long access time has been proposed (see Patent Literature 1, for example). In a case in which writing of data for high-speed reading is designated in the system, an NVRAM successive sector number of sectors in writing data is written in the NVRAM, and remaining sectors are written in the flash memory. Meanwhile, in a case in which the writing of data for high-speed reading is not designated, all the writing data is written in the flash memory.

### CITATION LIST

### Patent Literature

Patent Literature 1: JP 2013-142947A

### SUMMARY OF INVENTION

### Technical Problem

According to the aforementioned conventional technology, it is possible to write data in a high-speed readable memory in advance to prepare for high-speed reading. In contrast, it takes time to write data in the high-speed readable memory in some cases, and there is a concern that performance of the storage system will deteriorate during execution of a writing command.

The present technology has been achieved in view of such circumstances, and an object thereof is to perform both writing and reading at a high speed by utilizing a first memory and a second memory that has a lower writing speed and a higher reading speed than the first memory.

### Solution to Problem

The present technology has been made to solve the above problem. According to a first aspect of the present technology, there is provided a memory control device, a storage device, and an information processing system. The memory control device includes: a writing unit that writes writing data related to a writing command in a first memory when the writing command is executed; a transfer unit that transfers the writing data from the first memory to a second memory at a predetermined timing; and a reading unit that performs reading of reading data from the second memory with higher priority than from the first memory when a reading command is executed. This leads to an effect that reading from the second memory is performed with higher priority than from the first memory by writing the writing data in the first memory while transferring the writing data from the first memory to the second memory in advance.

In other words, according to the first aspect, the reading unit may perform reading from the second memory in a case in which the reading data of the reading command is stored in the second memory and performs reading from the first memory in a case in which the reading data is not stored in the second memory. Here, according to the first aspect, the second memory may have a lower writing speed than the first memory and has a higher reading speed than the first memory.

In addition, according to the first aspect, the transfer unit may execute the transfer in response to issuance of a data transfer command. This leads to an effect that the transfer from the first memory to the second memory is triggered by a data transfer command.

In addition, according to the first aspect, the memory control device may further include a timer that times an idling period during which issuance of the writing command or the reading command is not received. The transfer unit may execute the transfer if the timer detects that the idling period has continued for a predetermined period. This leads to an effect that the transfer from the first memory to the second memory is triggered by continuation of an idling period.

In addition, according to the first aspect, the transfer unit may execute the transfer in a period during which reading of data from the second memory does not occur. This leads to an effect that the transfer from the first memory to the second memory is triggered by a period during which reading of data from the second memory does not occur.

In addition, according to the first aspect, the memory control device may further include a progress information holding unit that holds progress information of the transfer. The transfer unit may update the progress information held by the progress information holding unit during execution of the transfer. This leads to an effect that progress information is maintained even in a case in which interruption or the like has occurred in the progress of the transfer. In other words, in this case, the transfer unit may interrupt the transfer in response to issuance of another command during execution of the transfer, and restart the transfer in accordance with the progress information after processing of the other command is completed.

In addition, according to the first aspect, in a case in which overwriting occurs in the first memory due to another writing command after the writing data is transferred from the first memory to the second memory, the transfer unit may regard the transfer as not having been performed. This leads to an effect that the transfer becomes invalid in a case in which overwriting occurs.

In addition, according to the first aspect, in a case in which overwriting occurs in the first memory due to another writing command after the writing data is transferred from the first memory to the second memory, the transfer unit may compare the transferred writing data with writing data related to the other writing command, and the transfer unit may transfer the writing data related to the other writing command from the first memory to the second memory only in a case in which the transferred writing data and the writing data related to the other writing command are different from each other. This leads to an effect that unnecessary transfer is suppressed when content of data coincides even in a case in which overwriting occurs.

In addition, according to the first aspect, the transfer unit may select data to be transferred from the first memory to the second memory on a basis of an address related to the writing command. In addition, according to the first aspect, the transfer unit may select data to be transferred from the first memory to the second memory on a basis of an address related to the reading command. In addition, according to the first aspect, the transfer unit may select data to be transferred from the first memory to the second memory on a basis of an address designated by another command that is different from the writing command and the reading command.

### Advantageous Effects of Invention

According to the present technology, it is possible to achieve an excellent effect that both writing and reading can be performed at a high speed by utilizing a first memory and a second memory that has a lower writing speed and a higher reading speed than the first memory. Note that effects described herein are not necessarily limitative, and any effect that is desired to be described in the present disclosure may be admitted.

### BRIEF DESCRIPTION OF DRAWINGS

FIG. 1 is a diagram illustrating an overall configuration example of an information processing system according to an embodiment of the present technology.

FIG. 2 is a diagram illustrating a configuration example of a host computer 100 according to the embodiment of the present technology.

FIG. 3 is a diagram illustrating an example of a hierarchical structure of software that operates on the host computer 100 according to the embodiment of the present technology.

FIG. 4 is a diagram illustrating a configuration example of a memory controller 200 according to the embodiment of the present technology.

FIG. 5 is a diagram illustrating a functional configuration example of a controller processing unit 210 according to the embodiment of the present technology.

FIG. 6 is a diagram illustrating a configuration example of a first memory 310 according to the embodiment of the present technology.

FIG. 7 is a diagram illustrating an example of a table group that is held by a controller memory 220 according to the embodiment of the present technology.

FIG. 8 is a diagram illustrating a field configuration example of an address conversion table 221 according to the embodiment of the present technology.

FIG. 9 is a diagram illustrating a field configuration example of a data arrangement information management table 224 according to the embodiment of the present technology.

FIG. 10 is a diagram illustrating an example of page configurations of memory cell arrays 311 and 312 in a first memory 310 according to the embodiment of the present technology.

FIG. 11 is a diagram illustrating an example of a page configuration of a memory cell array in a second memory 320 according to the embodiment of the present technology.

FIG. 12 is a flow diagram illustrating an example of a processing procedure for writing command processing according to a first embodiment of the present technology.

FIG. 13 is a flow diagram illustrating an example of a processing procedure for data arrangement information management table logical address updating processing according to the first embodiment of the present technology.

FIG. 14 is a flow diagram illustrating an example of a processing procedure for data transfer processing according to the first embodiment of the present technology.

FIG. 15 is a flow diagram illustrating an example of a processing procedure for reading command processing according to the first embodiment of the present technology.

FIG. 16 is a flow diagram illustrating an example of a processing procedure for high-speed reading processing (Step S980) according to the first embodiment of the present technology.

FIG. 17 is a flow diagram illustrating an example of a processing procedure for data arrangement information management table logical address updating processing according to a first modification example of the first embodiment of the present technology.

FIG. 18 is a flow diagram illustrating an example of a processing procedure for second memory data verification processing according to the first modification example of the first embodiment of the present technology.

FIG. 19 is a diagram illustrating a configuration example of a memory controller 200 according to a third modification example of the first embodiment of the present technology.

FIG. 20 is a flow diagram illustrating an example of a processing procedure for data transfer processing according to a fourth modification example of the first embodiment of the present technology.

FIG. 21 is a flow diagram illustrating an example of a processing procedure for writing command processing according to a second embodiment of the present technology.

FIG. 22 is a flow diagram illustrating an example of a processing procedure for data arrangement information management table logical address updating processing according to the second embodiment of the present technology.

FIG. 23 is a flow diagram illustrating an example of a processing procedure for reading command processing according to the second embodiment of the present technology.

FIG. 24 is a flow diagram illustrating an example of a processing procedure for logical address registration command processing according to a third embodiment of the present technology.

### DESCRIPTION OF EMBODIMENTS

Hereinafter, embodiments for carrying out the present technology (hereinafter referred to as embodiments) will be described. Description will be given in the following order.
1. First embodiment (example in which information for arranging data in second memory is acquired by writing command)
2. Second embodiment (example in which information for arranging data in second memory is acquired by reading command)
3. Third embodiment (example in which information for arranging data in second memory is acquired by dedicated command)

### 1. First Embodiment

### [Configuration of Information Processing System]

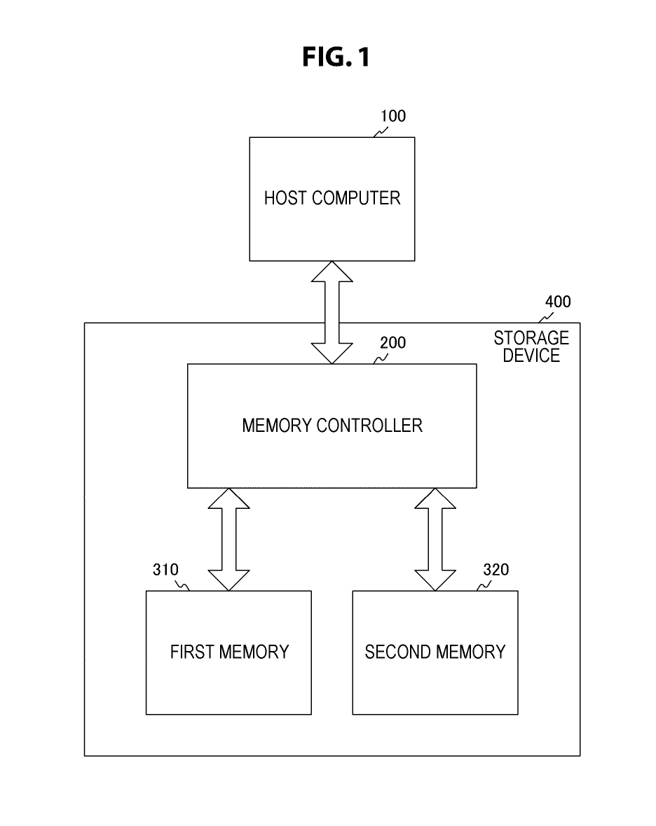

FIG. 1 is a diagram illustrating an overall configuration example of an information processing system according to an embodiment of the present technology. The information processing system includes a host computer 100, a memory controller 200, a first memory 310, and a second memory 320. The memory controller 200, the first memory 310, and the second memory 320 form a storage device 400.

The host computer 100 issues a command for requesting the storage device 400 to perform reading processing, writing processing, and the like of data.

The memory controller 200 communicates with the host computer 100, receives a command, and executes writing of data in the first memory 310 or the second memory 320 and reading of data from the first memory 310 or the second memory 320. In a case in which a writing command is received, the memory controller 200 provides an instruction for writing the data received from the host computer 100 in the first memory 310 or the second memory 320. In addition, in a case in which a reading command is received, the memory controller 200 reads data from the first memory 310 or the second memory 320 and transfers the data to the host computer 100. In the reading command and the writing command, a head logical address of a target region and the number of logical pages from the head logical address are used to designate a data storage region as a target of access.

A storage region for reading and writing data in the storage device 400 is divided into logical pages at every 512 bytes, and logical addresses are uniquely assigned to the respective logical pages.

The first memory 310 is a memory that has a high writing speed. For example, a resistive memory is assumed as the first memory 310. An access unit is assumed to be 264 bytes, a time required from reception of a reading request to output of data (reading busy time) is assumed to be 2.5 microseconds, and a time from reception of a writing request to completion of writing (writing busy time) is assumed to be 10 microseconds.

The second memory 320 is a memory that has a lower writing speed than the first memory 310 and has a higher reading speed than the first memory 310. For example, a NOR-type flash memory is assumed as the second memory 320. An access unit is assumed to be 2 bytes, a reading busy time is assumed to be 20 nanoseconds, and a writing busy time is assumed to be 19.1 microseconds.

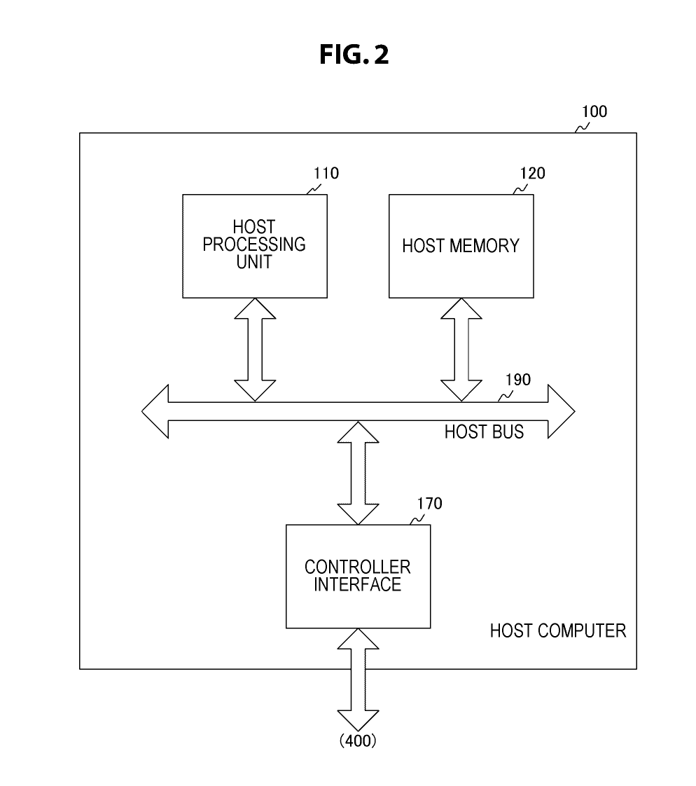

FIG. 2 is a diagram illustrating a configuration example of the host computer 100 according to the embodiment of the present technology. The host computer 100 includes a host processing unit 110, a host memory 120, and a controller interface 170. These are connected to each other by a host bus 190.

The host processing unit 110 performs control on the entire host computer 100. The host processing unit 110 executes software saved in the host memory 120. The host processing unit 110 operates by using the host memory 120 as a code region and a data region.

The host memory 120 is a memory that stores the code region and the data region of the software executed by the host processing unit 110.

The controller interface 170 is an interface that interacts with the memory controller 200. The controller interface 170 is connected to the memory controller 200 and executes transmission of a command to the memory controller 200 and transmission and reception of data to and from the memory controller 200.

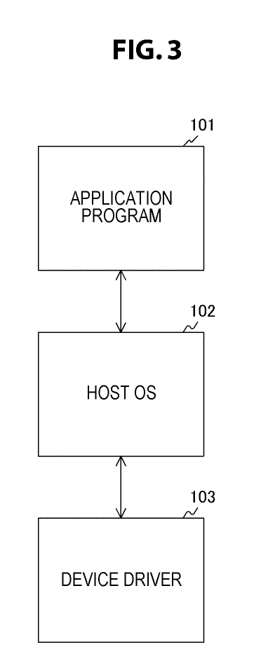

FIG. 3 is a diagram illustrating an example of a hierarchical structure of software that operates on the host computer 100 according to the embodiment of the present disclosure. Here, an application program 101, a host OS 102, and a device driver 103 are assumed from an upper level of the software.

The application program 101 is software of the uppermost level. The application program 101 provides an instruction for reading data from the storage device 400 or writing data from the storage device 400 to the host OS 102 and receives a response from the host OS 102.

The host OS 102 is an operating system (OS) that serves as a bridge between the application program 101 and the device driver 103. The host OS 102 provides an instruction for reading data from the storage device 400 or writing data from the storage device 400 to the device driver 103 and receives a response from the device driver 103.

The device driver 103 is software that controls hardware. The device driver 103 provides an instruction for reading data from the storage device 400 or writing data from the storage device 400 to the memory controller 200 and receives a response from the memory controller 200.

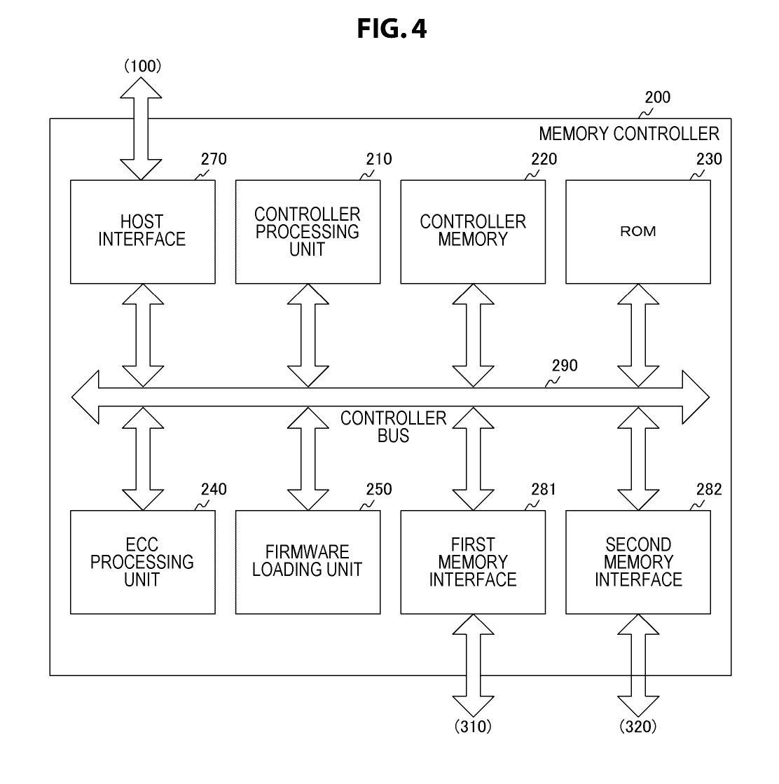

FIG. 4 is a diagram illustrating a configuration example of the memory controller 200 according to the embodiment of the present technology. The memory controller 200 includes a controller processing unit 210, a controller memory 220, a ROM 230, an ECC processing unit 240, a firmware loading unit 250, a host interface 270, a first memory interface 281, and a second memory interface 282. These are connected to each other by a controller bus 290.

The controller processing unit 210 performs control on the entire memory controller 200. The controller processing unit 210 executes firmware saved in the controller memory 220. The controller processing unit 210 operates by using the controller memory 220 as a code region and a data region.

The controller memory 220 is a memory that stores the code region and the data region of the firmware executed by the controller processing unit 210. In addition, the controller memory 220 is also used as a region for developing tables for managing user data. Details of these tables will be described later.

The ROM 230 is a memory dedicated to reading, and stores firmware saved in the controller memory 220. A control task and a command execution task are included in the firmware.

The ECC processing unit 240 generates an error correcting code (ECC) for data to be stored in the first memory 310 and performs error correcting processing on data read from the first memory 310.

The firmware loading unit 250 reads the firmware from the ROM 230 to the controller memory 220 if the storage device 400 is turned on.

The host interface 270 is an interface that interacts with the host computer 100. The memory interface 281 is an interface that interacts with the first memory 310. The memory interface 282 is an interface that interacts with the second memory 320.

A control task and a command execution task operate on the controller processing unit 210. If a command is received from the host computer 100, the command is decoded in the control task. Then, in a case of a reading command for reading data from the first memory 310 or the second memory 320 or a writing command for writing data in the first memory 310 or the second memory 320, the command execution task is called, and corresponding processing is performed.

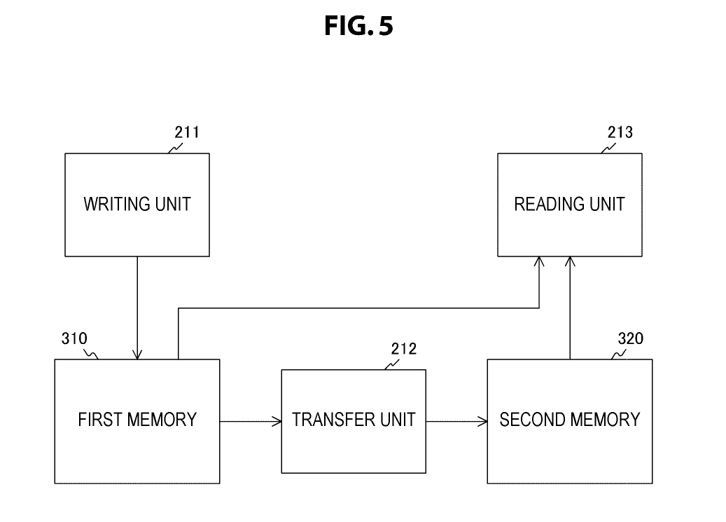

FIG. 5 is a diagram illustrating a functional configuration example of the controller processing unit 210 according to the embodiment of the present disclosure. The controller processing unit 210 functions as the writing unit 211, the transfer unit 212, and the reading unit 213, for example.

The writing unit 211 writes writing data related to a writing command in the first memory 310 when the writing unit 211 executes the writing command. Since the first memory 310 has a lower reading speed than the second memory 320 and has a higher writing speed than the second memory 320, the writing performed by the writing unit 211 can be performed at a high speed.

The transfer unit 212 transfers the writing data stored in the first memory 310 from the first memory 310 to the second memory 320 at a predetermined timing. As the predetermined timing, a timing at which issuance of the data transfer command is received from the host computer 100 is assumed in a first embodiment.

The reading unit 213 performs reading of reading data from the second memory 320 with higher priority than from the first memory 310 when the reading unit 213 executes a reading command. That is, the reading unit 213 performs reading from the second memory 320 in a case in which the reading data of the reading command is stored in the second memory 320 and performs reading from the first memory 310 in a case in which the reading data is not stored in the second memory 320. Since the second memory 320 has a higher reading speed than the first memory 310 while the secondary memory has a lower writing speed than the first memory 310, it is possible to perform reading at a high speed in a case in which the reading data is stored in the second memory 320.

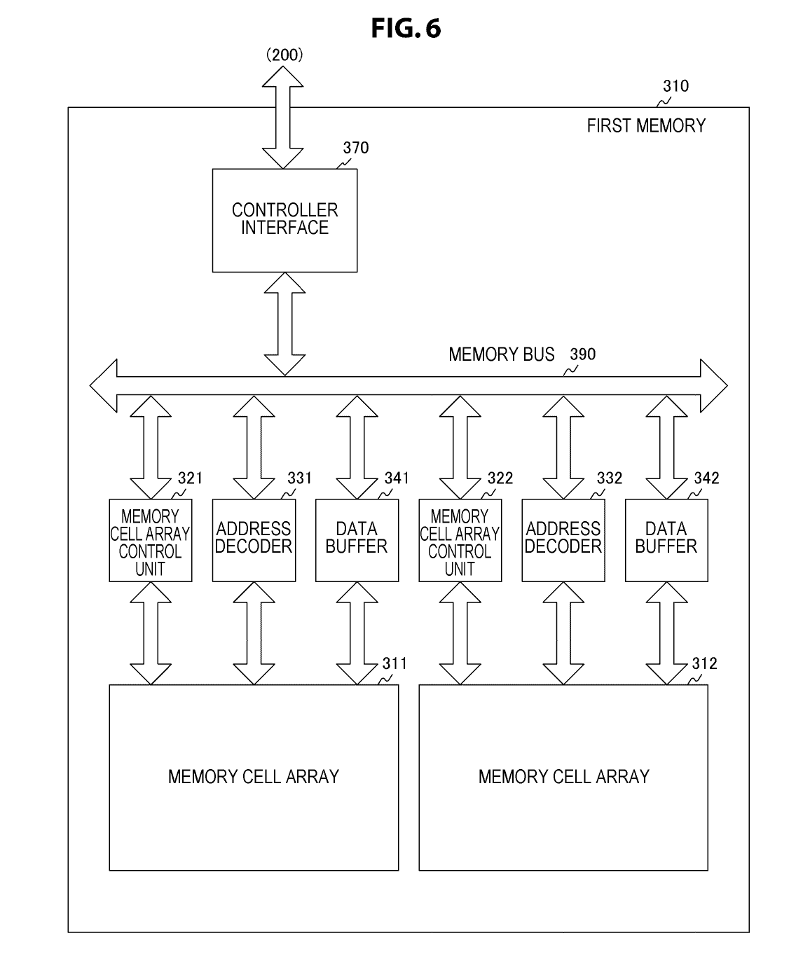

FIG. 6 is a diagram illustrating a configuration example of the first memory 310 according to the embodiment of the present disclosure. The first memory 310 includes memory cell arrays 311 and 312, memory cell array control units 321 and 322, address decoders 331 and 332, data buffers 341 and 342, and a controller interface 370. The memory cell array control unit 321, the address decoder 331, and the data buffer 341 are connected to the memory cell array 311. The memory cell array control unit 322, the address decoder 332, and the data buffer 342 are connected to the memory cell array 312. These are connected to the controller interface 370 via a memory bus 390.

The memory cell arrays 311 and 312 are storage elements with memory cells for storing data integrated thereon in an array shape. Here, the memory cell arrays 311 and 312 are assumed to include two memory banks, and the memory cell array 311 will be referred to as a bank #0 while the memory cell array 312 will be referred to as a bank #1. However, one memory cell array may be provided. The memory cell array control units 321 and 322 execute control on the memory cell arrays 311 and 312. The address decoders 331 and 332 are decoders that decode addresses for the memory cell arrays 311 and 312. The data buffers 341 and 342 are buffers for accessing the memory cell arrays 311 and 312. The controller interface 370 is an interface that interacts with the memory controller 200.

Physical addresses are assigned to the memory cell arrays 311 and 312, and the physical addresses are designated for a writing request and reading request with respect to the first memory 310.

Note that a configuration of the second memory 320 is basically similar to that of the first memory 310. However, a plurality of memory banks are not assumed for the second memory 320, and the second memory 320 includes have one memory cell array.

The controller interface 370 determines whether a request received from the first memory interface 281 is a writing request or a reading request and which of a bank #0 and a bank #1 the request is for.

In the case of a writing request for the bank #0, received writing data is transferred to the data buffer 341 from the controller interface 370. Then, the physical address is input to the address decoder 331, and an instruction for executing writing is provided to the memory cell array control unit 321. If the controller interface 370 is notified of completion of the execution of the writing from the memory cell array control unit 321, the controller interface 370 notifies the first memory interface 281 of the completion of the writing request.

In the case of a reading request for the bank #0, the physical address is input from the controller interface 370 to the address decoder 331, and an instruction for executing reading is provided to the memory cell array control unit 321. If the data read from the memory cell array 331 is transferred to the data buffer 341, the controller interface 370 is notified of completion of the execution of the reading from the memory cell array control unit 321. In this manner, the controller interface 370 transmits the read data from the data buffer 341 to the first memory interface 281 and completes the reading request.

Note that, although the request processing with respect to the bank #0 has been described here, the same applies to the request processing with respect to the bank #1.

### [Table Group Held by Controller Memory]

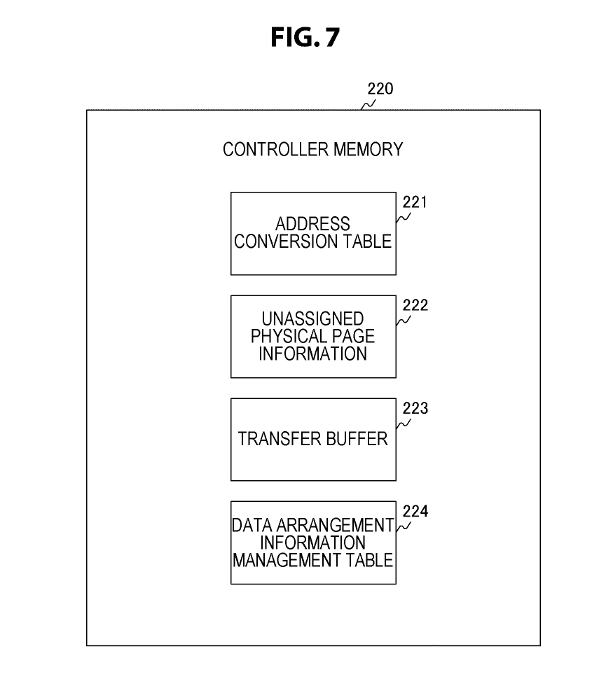

FIG. 7 is a diagram illustrating an example of a table group held by the controller memory 220 according to the embodiment of the present technology. Here, an address conversion table 221, unassigned physical page information 222, a transfer buffer 223, and a data arrangement information management table 224 are illustrated as the table group held by the controller memory 220.

The address conversion table 221, the unassigned physical page information 222, and the data arrangement information management table 224 are read from the first memory 310 and are developed in the controller memory 220 when the storage device 400 is turned on. In addition, these are evacuated in the first memory 310 from the controller memory 220 when the storage device 400 is turned off. Note that, although the address conversion table 221, the unassigned physical page information 222, and the data arrangement information management table 224 are assumed to be evacuated in the first memory 310 here, they may be evacuated in the second memory 320.

The address conversion table 221 is a table that holds addresses of physical pages (physical addresses) assigned to the logical addresses. A field configuration of the address conversion table 221 will be described later.

The unassigned physical page information 222 holds addresses of physical pages (physical addresses) that have not been used for recording data in each of the first memory 310 and the second memory 320. In a case in which the physical addresses are acquired from the unassigned physical page information 222, addresses are acquired in ascending order from smaller physical address values.

The transfer buffer 223 is a buffer region for transferring data from the first memory 310 to the second memory 320.

The data arrangement information management table 224 is a table for managing arrangement information of data in the second memory 320. A field configuration of the data arrangement information management table 224 will be described later. Note that the data arrangement information management table 224 is an example of the progress information holding unit described in the claims.

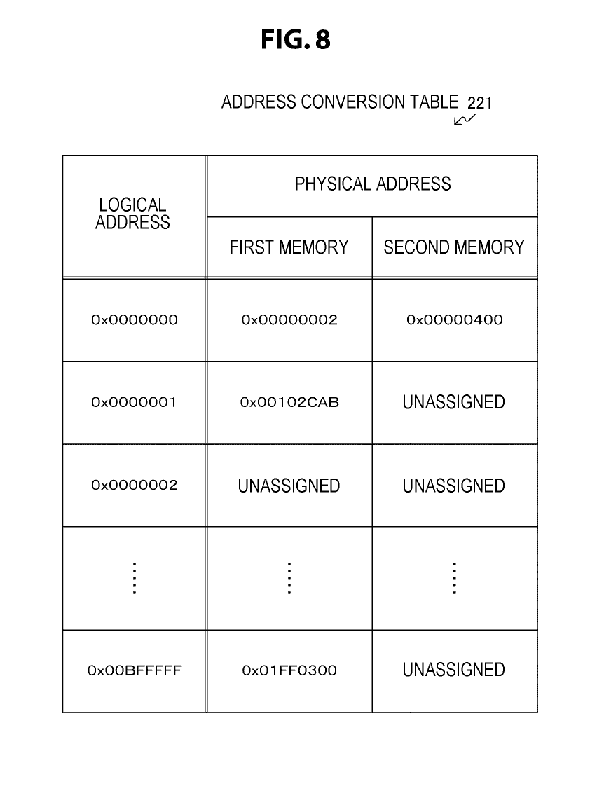

FIG. 8 is a diagram illustrating a field configuration example of the address conversion table 221 according to the embodiment of the present technology. The address conversion table 221 includes the respective fields, namely “logical address”, “physical address” of “first memory”, and “physical address” of “second memory”. Although a physical address assigned to a corresponding logical address is held in “physical address”, content indicating an address is “unassigned” is represented in a case in which a corresponding logical address has not been assigned. In a case in which an address is represented in “physical address” of “second memory”, it means that transfer from the first memory 310 to the second memory 320 has already been performed. Note that numbers following “0x” mean hexadecimal numbers.

The size of each physical page in the first memory 310 is 264 bytes, and data of one logical page is divided into two physical pages and is then saved. As the physical pages assigned to one logical page, two physical pages with continuous addresses are assigned. In the address conversion table 221, only a physical address with a smaller value of the two continuous physical pages is held. 528-byte data in one logical page is divided into two data items, namely into 264 bytes of the first half and 264 bytes of the second half, and 264 bytes of the first half is saved in the physical page with the physical address of a smaller value while 264 bytes of the second half is saved in the physical page with the physical address of a larger value.

Note that the data in one logical page is assumed to be divided into two physical pages with continuous addresses and be recorded into the first memory 310 here in order to simplify the address conversion table 221. Meanwhile, the data may be assigned to physical pages with addresses that are not continuous, by causing two physical pages to be linked to one logical address and recording the data in the address conversion table 221.

The size of each physical page in the second memory 320 is 2 bytes, and data corresponding to 256 bytes from the head in the data in one logical page is recorded in the second memory 320. For recording continuous data of 256 bytes, continuous 128 physical pages are assigned. In the address conversion table 221, only a physical address with the smallest value is held from among the continuous 128 physical pages.

Note that data can also be recorded in physical pages with addresses that are not continuous in the second memory 320 in a manner similar to that in the first memory 310.

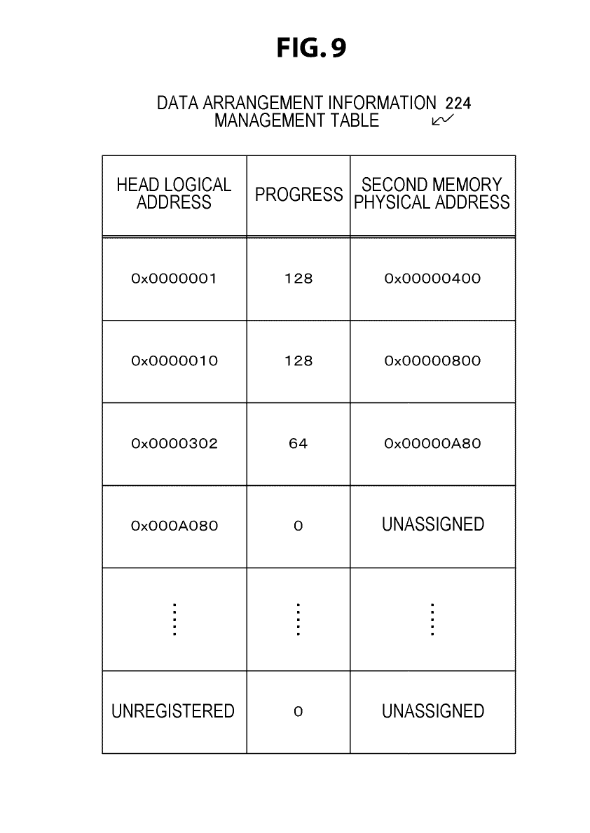

FIG. 9 is a diagram illustrating a field configuration example of the data arrangement information management table 224 according to the embodiment of the present technology. The data arrangement information management table 224 includes the respective fields, namely “head logical address”, “progress”, and “second memory physical address”.

In “head logical address”, a head logical address designated by a writing command is registered.

In “progress”, the size of data that has already been transferred from the first memory 310 to the second memory 320 is managed in units of numbers of physical pages in the second memory 320. If “progress” is “0”, it means that all the pages are in a non-transferred state. Here, an upper limit value in “progress” is assumed to be “128”.

In “second memory physical address”, a head physical address from among physical pages with addresses of continuous values in the second memory 320, which has been saved by data with addresses registered in “head logical address” being transferred, is held.

### [Storage Region in Memory]

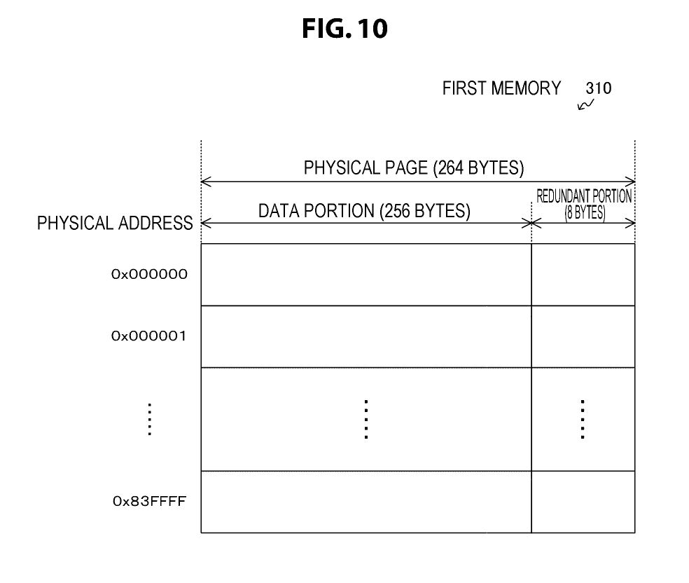

FIG. 10 is a diagram illustrating an example of page configurations of the memory cell arrays 311 and 312 in the first memory 310 according to the embodiment of the present technology.

A physical address is assigned to every 264 bytes for the memory cell arrays 311 and 312. Writing in the first memory 310 and reading from the first memory 310 are executed in units of 264-byte physical pages.

From among physical addresses, even number addresses are assigned to the memory cell array 311 while add number addresses are assigned to the memory cell array 312.

Data to be written in one physical page includes 256-byte data and a redundant portion that accompanies the data. In this example, the redundant portion is an 8-byte ECC. The ECC is added by the ECC processing unit 240 of the memory controller 200.

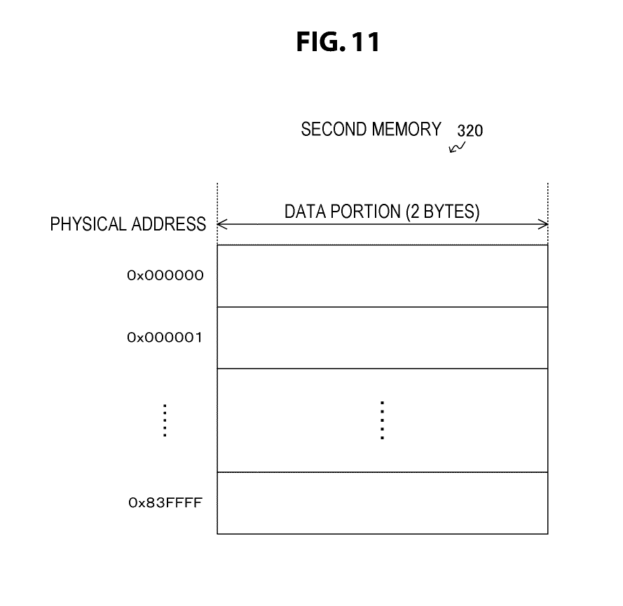

FIG. 11 is a diagram illustrating an example of a page configuration of a memory cell array in the second memory 320 according to the embodiment of the present technology.

A physical address is assigned to every 2 bytes for the memory cell array in the second memory 320. Writing and reading of data in the memory cell array in the second memory 320 are executed in units of 2-byte physical addresses.

### [Operations of Information Processing System]

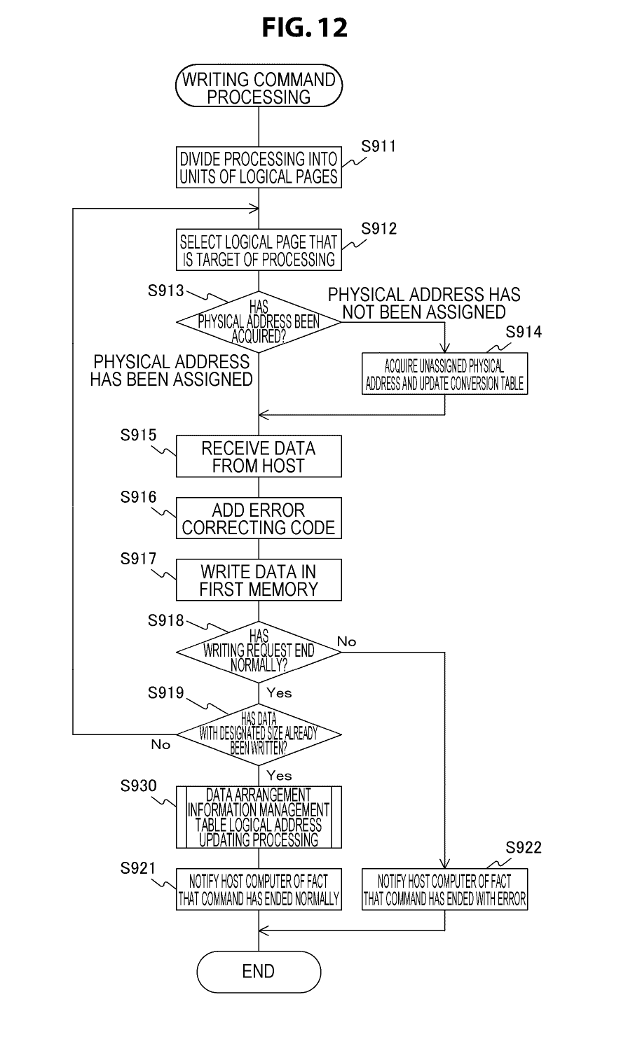

FIG. 12 is a flow diagram illustrating an example of a processing procedure for writing command processing according to the first embodiment of the present technology. The writing command processing is processing that is executed when the memory controller 200 receives a writing command from the host computer 100. The following processing is executed in a command execution task.

The controller processing unit 210 divides the processing in units of logical addresses on the basis of a received head logical address and the number of logical pages (Step S911). It is one logical address that is executed in processing performed one time. In a case in which “0” is designated as a starting address of a target of writing and “1” is designated as the size, for example, processing is performed one time. In addition, in a case in which “0” is designated as a head logical address of the target of writing and “2” is designated as the size, the processing is divided into two processes.

The controller processing unit 210 decides a logical address that is a target of writing (Step S912). The logical address that is a target is decided in an order from the head logical address that is a target of writing. In a case in which “0” is designated as the head logical address that is a target of writing and “2” is designated as the data size, for example, the logical address on which the processing is executed first is decided to be “0”. Then, the logical address that will be a target next is decided to be “1”.

The controller processing unit 210 converts the logical address decided as a target of writing in Step S912 into a physical address by using the address conversion table 221 held by the controller memory 220 (Step S913). At his time, in a case in which the physical address has been assigned to the logical address selected in Step S912, two physical addresses, namely the physical address converted by using the address conversion table 221 and a physical address obtained by incrementing the converted physical address are acquired.

Meanwhile, in a case in which the physical address cannot be acquired since no physical address has been assigned, the controller processing unit 210 acquires two unused physical addresses, values of which are continuous, from the unassigned physical page information 222 (Step S914). The unused physical addresses are selected in an ascending order from the address with a smaller value. At that time, the controller processing unit 210 updates a value of a physical address corresponding to the logical address selected in Step S912 in the address conversion table 221 to the physical address with the smaller value in the acquired physical addresses.

The controller processing unit 210 receives 512-byte data from the host computer 100 via the host interface 270 (Step S915). Then, the received 512-byte data is divided into 256 bytes of a first half and 256 bytes of a second half. The ECC processing unit 240 adds 8-byte error correcting code to each of the first half and the second half (Step S916).

The controller processing unit 210 designates the two physical addresses acquired in Step S913 or S914, issues a writing request two times with respect to the first memory 310, and writes data (Step S917).

The controller processing unit 210 determines whether or not both the two writing requests issued in Step S917 have ended normally (Step S918). In a case in which the writing requests have not ended normally (Step S918: No), the controller processing unit 210 notifies the host computer 100 of the fact that an error has occurred in the processing of the writing command (Step S922). If the writing requests have ended normally (Step S918: Yes), the controller processing unit 210 determines whether or not a total size of data written in the first memory 310 in the processing of the writing command coincides with the data size designated by the writing commands (Step S919). In a case in which the writing of the data with the size designated by the writing command has not been completed (Step S919: No), processing in Step S912 and the following steps is repeated.

If the writing of the data with the size designated by the writing command has been completed (Step S919: Yes), the controller processing unit 210 executes data arrangement information management table logical address updating processing by using the received head logical address as an input (Step S930). That is, data to be transferred from the first memory 310 to the second memory 320 is selected on the basis of the logical address of the writing command in the first embodiment.

Thereafter, the controller processing unit 210 notifies the host computer 100 of the fact that the processing of the writing command has ended normally (Step S921).

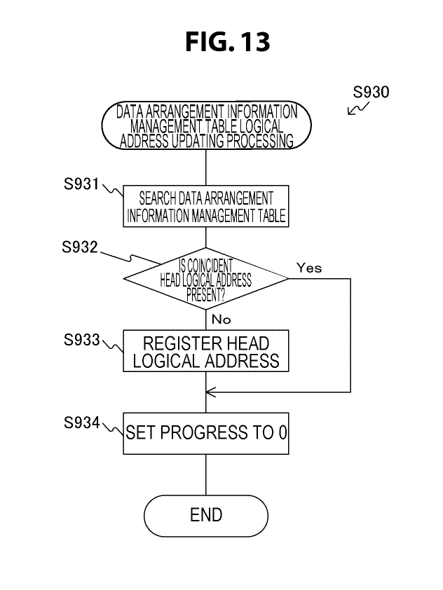

FIG. 13 is a flow diagram illustrating an example of a processing procedure for the data arrangement information management table logical address updating processing (Step S930) according to the first embodiment of the present disclosure. As for the data arrangement information management table logical address updating processing, the processing is performed by using the logical address as an input. The following processing is executed in the command execution task.

The controller processing unit 210 searches for a logical address that coincides with the input logical address from “head logical address” in the data arrangement information management table 224 (Step S931). In a case in which coinciding “head logical address” is not present in the data arrangement information management table 224 (Step S932: No), it means that the logical address has not been registered in the data arrangement information management table 224. In that case, the controller processing unit 210 adds the input logical address to “head logical address” in the data arrangement information management table 224 (Step S933).

The controller processing unit 210 updates a value of “progress” corresponding to “head logical address”, with which the input logical address coincide”, in the data arrangement information management table 224 to “0” (Step S934). This represents a state in which the data written in the first memory 310 by the writing command processing has not been transferred to the second memory 320.

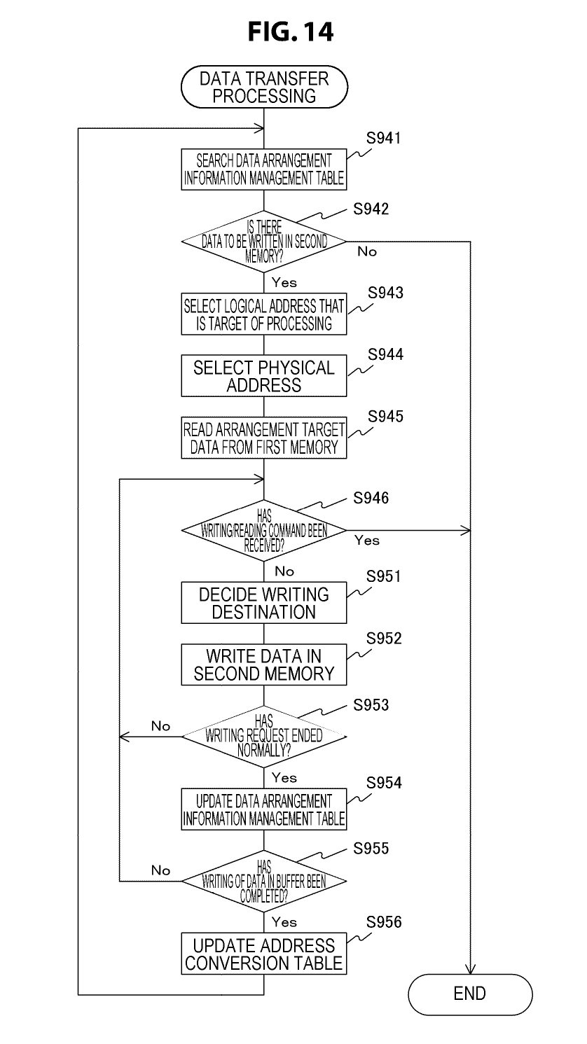

FIG. 14 is a flow diagram illustrating an example of a processing procedure for data transfer processing according to the first embodiment of the present technology. The host OS 102 or the application program 101 monitors a state (idling state) in which an input or an output to or from the storage device 400 has not occurred. If it is detected that the idling state has continued for a predetermined period, the host OS 102 or the application program 101 issues a data transfer command for the storage device 400 and provides an instruction for executing data transfer processing via the device driver 103.

The controller processing unit 210 searches for a logical address with a corresponding “progress” value that is less than a maximum value from among logical addresses with valid “head logical address” values in the data arrangement information management table 224 by a control task (Step S941). In a case in which the corresponding logical address is not present at this time (Step S942: No), the data transfer processing ends on the assumption that data to be transferred to the second memory 320 is not present.

In a case in which data to be transferred is present (Step S942: Yes), the controller processing unit 210 selects a logical address with a corresponding “progress” value that is a maximum from among the logical addresses corresponding to a search result in Step S941 by the control task. In a case in which a plurality of maximum values are present at this time, a logical address with the smallest value in the data arrangement information management table 224 is selected.

The controller processing unit 210 converts the logical address selected in Step S943 into a physical address by using the address conversion table 221 (Step S944). The physical address acquired here is only a physical address with a smaller value in the two physical addresses in the first memory 310 corresponding to the logical address selected in Step S943.

The controller processing unit 210 designate the physical address converted in Step S944 and issues a reading request for the first memory 310 by the control task. Then, the ECC processing unit 240 performs error correction on the read 264-byte data. The thus obtained 256 bytes including only a data portion is held by the transfer buffer 223 (Step S945).

The controller processing unit 210 determines whether or not the host interface 270 has received a writing command or a reading command from the host computer 100 by a command execution task (Step S946). In a case in which the host interface 270 has received the writing command or the reading command (Step S946: Yes), the data transfer processing ends.

The controller processing unit 210 acquires a physical address of data that has not been recorded in the second memory 320 from the unassigned physical page information 222 by the control task (Step S951).

The controller processing unit 210 acquires a “progress” value n corresponding to the logical address selected in Step S943 from the data arrangement information management table 224 by the control task. Then, the controller processing unit 210 designates the physical address acquired in Step S951 for 2-byte data from the 2×n-th byte from the head of the data held by the transfer buffer 223 and issues a writing request for the second memory 320 (Step S952). That is, even in a case in which data transfer has been interrupted before then, transfer is restarted from the position indicated by “progress”.

The controller processing unit 210 determines whether or not the writing request in Step S952 has ended normally by the control task (Step S953). In a case in which the writing request has not ended normally (Step S953: No), the processing in Step S946 and the following steps is repeated. In a case in which the writing request has ended normally (Step S953: Yes), the “progress” value n corresponding to the logical address selected in Step S943 is incremented, and the value of the data arrangement information management table 224 is updated (Step S954).

At this time, the controller processing unit 210 determines whether or not the updated “progress” value coincides with the maximum value (Step S955). In a case in which the value does not coincide with the maximum value (Step S955: No), the processing in Step S946 and the following steps is repeated on the assumption that the writing of the data from the transfer buffer 223 in the second memory 320 has not been completed.

In a case in which the value coincides with the maximum value (Step S955: Yes), the address conversion table 221 is updated on the assumption that the writing of the data from the transfer buffer 223 in the second memory 320 has been completed (Step S956). That is, the controller processing unit 210 updates the “physical address” value corresponding to the logical address selected in Step S943 in the address conversion table 221 to the physical address that has been written in the second memory 320 and repeats the processing in Step S941 and the following steps.

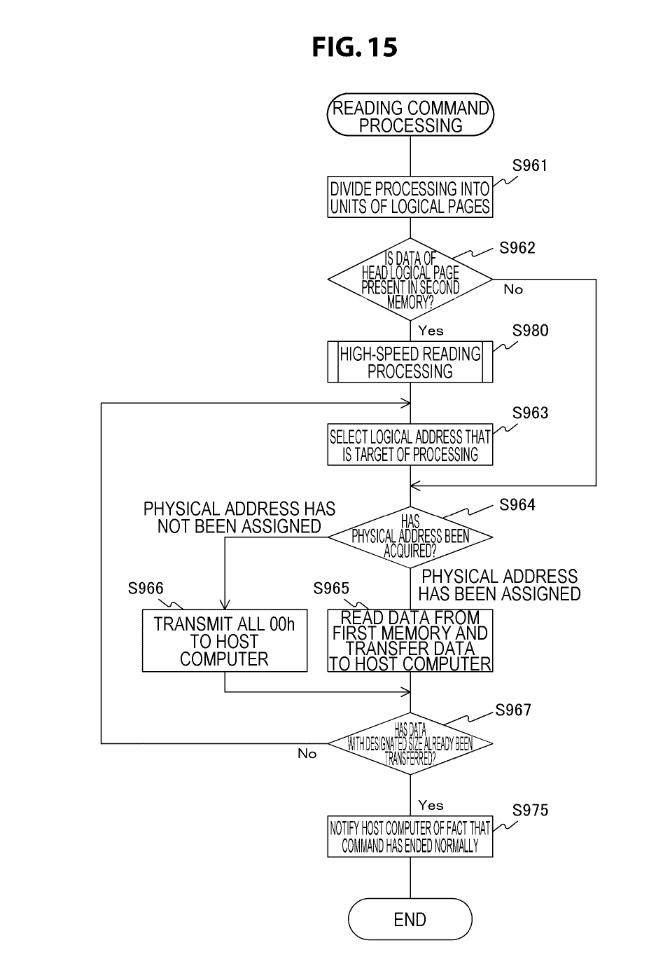

FIG. 15 is a flow diagram illustrating an example of a processing procedure for reading command processing according to the first embodiment of the present technology. The reading command processing is processing that is executed when the memory controller 200 receives a reading command from the host computer 100. The following processing is executed by a command execution task.

The controller processing unit 210 divides the processing into logical address units on the basis of the received head logical address and the number of logical pages (Step S961). One logical address is executed in processing performed one time. In a case in which “0” is designated as a head address of a target of reading and “1” is designated as a size, for example, processing is performed one time. In addition, in a case in which “0” is designated as the head logical address of the target of reading and “2” is designated as the size, the processing is divided into two processes.

The controller processing unit 210 determines whether or not the head logical address designated by the reading command has been registered in “head logical address” in the data arrangement information management table 224 and the “progress” value has reached an upper limit value (Step S962). In a case in which the head logical address has been registered in “head logical address” and the “progress” value has reached the upper limit value (Step S962: Yes), Steps S980 and S963 are executed on the assumption that the target data is present in the second memory 320. In a case in which the head logical address has not been registered in “head logical address” or the “progress” value has not reached the upper limit value (Step S962: No), Steps S980 and S963 are not executed on the assumption that the target data is not present in the second memory 320.

In a case in which the target data is present in the second memory 320 (Step S962: Yes), the controller processing unit 210 executes high-speed reading processing by using the received head logical address as an input (Step S980). In addition, the controller processing unit 210 selects a logical address that is a target of reading (Step S963). The logical address that is a target is selected on an order from the logical address following the head logical address that is a target of reading.

The controller processing unit 210 converts the logical address selected as the target of reading in Step S963 to a physical address by using the address conversion table 221 held by the controller memory 220 (Step S964). At this time, in a case in which a physical address has been assigned to the logical address selected in Step S963, two physical addresses, namely the physical address converted by using the address conversion table 221 and a physical address obtained by incrementing the converted physical address are acquired. Then, the controller processing unit 210 designates the two physical addresses converted in Step S964, issues a reading request two times for the first memory 310, and reads 264-byte data two times. The ECC processing unit 240 performs error correction on the respective read data items, then remove the 8-byte error correcting codes, and transfer 256-byte data to the host computer 100 two times (Step S965).

Meanwhile, in a case in which the physical address cannot be acquired since no physical address has been assigned, the controller processing unit 210 transfers 512-byte data, the entire of which is 0x00, to the host computer 100 (Step S966).

The controller processing unit 210 determines whether or not a total size of data read from the first memory 310 and transferred to the host computer 100 in the reading command processing coincides with the data size designated by the reading commands (Step S967). In a case in which the reading of the data with the size designated by the reading command has not been completed (Step S967: No), processing in Step S963 and the following steps is repeated.

If reading of the data with the size designated by the reading command is completed (Step S967: Yes), the controller processing unit 210 notifies the host computer 100 of the fact that the processing of the reading command has ended (Step S975).

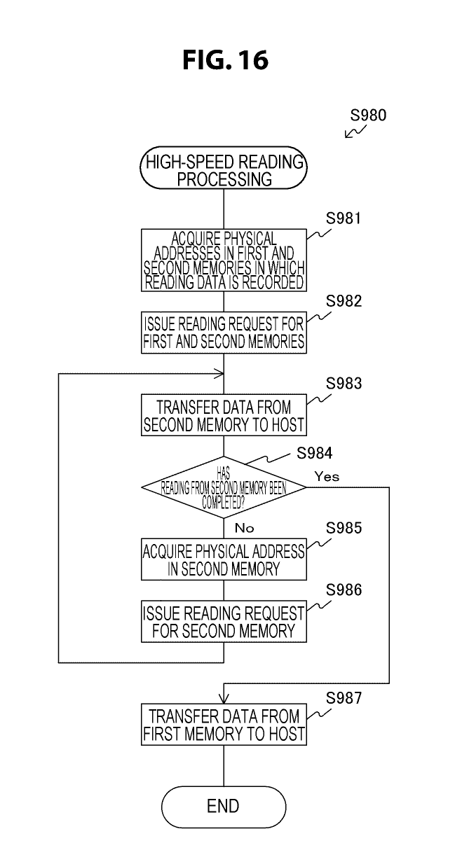

FIG. 16 is a flow diagram illustrating an example of a processing procedure for high-speed reading processing (Step S980) according to the first embodiment of the present technology. The following processing is executed by a command execution task.

The controller processing unit 210 acquires a physical address in the first memory 310 corresponding to the head logical address that is an input and a physical address in the second memory 320 from the address conversion table 221 (Step S981). The acquired physical address in the first memory 310 is a physical address with a larger value in the two physical addresses corresponding to the head logical address.

The controller processing unit 210 designates the physical address in the first memory 310 and the physical address in the second memory 320 acquired in Step S981 and issues a reading request for each of the first memory 310 and the second memory 320 (Step S982).

The controller processing unit 210 transfers 2-byte data read from the second memory 320 to the host computer 100 (Step S983).

The controller processing unit 210 determines whether or not the number of physical pages read from the second memory 320 has reached the upper limit value in the high-speed reading processing (Step S984). In a case in which the number of physical pages read from the second memory 320 has not reached the upper limit value (Step S984: No), the controller processing unit 210 acquires the physical address in the second memory 320 from the address conversion table 221 (Step S985). Then, the controller processing unit 210 designates the physical address in the second memory 320 acquired in Step S985 and issues a reading request for the second memory 320 (Step S986).

Meanwhile, in a case in which the number of physical pages read from the second memory 320 has reached the upper limit (Step S984: Yes), the controller processing unit 210 transfers data read from the first memory 310 to the host computer 100 (Step S987). At that time, the ECC processing unit 240 performs error correction on the read 264-byte data. Then, the controller processing unit 210 transfers 256-byte data, from which the 8-byte error correcting code has been removed, to the host computer 100.

In this manner, writing is performed in the first memory 310 that has a high writing speed in the writing command processing, and then if the storage device 400 is brought into the idling state, the data is transferred from the first memory 310 to the second memory 320 according to the first embodiment of the present technology. Then, the data that is present in the second memory 320 that has a high reading speed is read from the second memory 320 in the reading command processing. In this manner, it is possible to achieve both high-speed writing and high-speed reading.

### [First Modification Example]

In the aforementioned first embodiment, the data transfer from the first memory 310 to the second memory 320 are completely retried again in a case in which overwriting in the first memory 310 occurs in the writing command processing. Meanwhile, a first modification example is adapted on the assumption that data overwritten in the first memory 310 and data that has already been transferred to the second memory 320 are compared and the data in the second memory 320 is rewritten only in a case in which there is a difference.

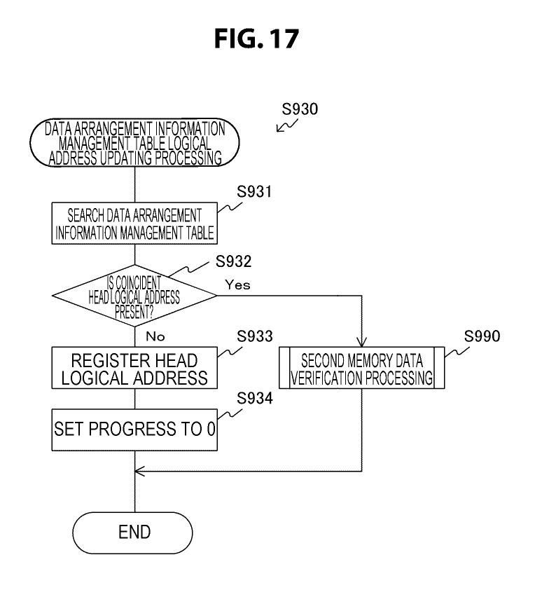

FIG. 17 is a flow diagram illustrating an example of a processing procedure for the data arrangement information management table logical address updating processing (Step S930) according to the first modification example of the first embodiment of the present technology.

In the data arrangement information management table logical address updating processing according to the first modification example, processing performed in a case in which the coincident “head logical address” is present in the data arrangement information management table 224 is different from that in the first embodiment, and other processing is similar to that in the first embodiment. That is, in a case in which coincident “head logical address” is present (Step S932: Yes), second memory data verification processing (Step S990) is executed in the first modification example.

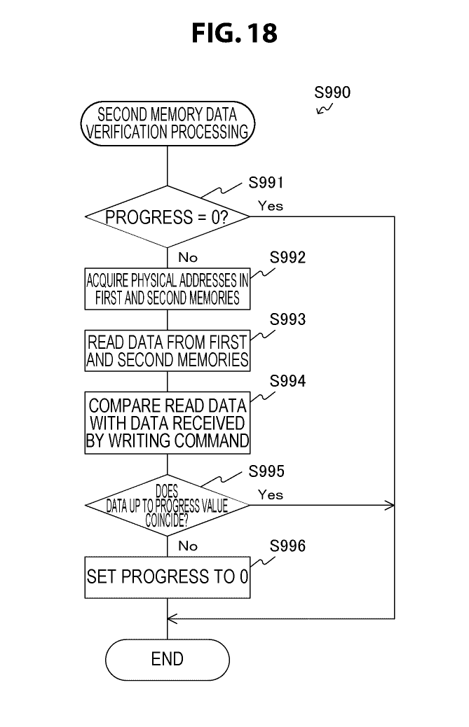

FIG. 18 is a flow diagram illustrating an example of a processing procedure for the second memory data verification processing (Step S990) according to the first modification example of the first embodiment of the present technology. In the second memory data verification processing, the processing is performed by using the head logical address designated by the writing command as an input. Note that it is assumed that the controller memory 220 includes a first memory verification buffer and a second memory verification buffer, which are not illustrated in the drawing, in the first modification example.

The controller processing unit 210 determines whether or not the “progress” value corresponding to the head logical address received as an input is “0” in the data arrangement information management table 224 (Step S991). If the “progress” value is “0” (Step S991: Yes), the second memory data verification processing ends since there is no need to perform comparison.

The controller processing unit 210 acquires the physical address in the first memory 310, which has been assigned to the head logical address received as an input, from the address conversion table 221 (Step S992). In addition, the controller processing unit 210 acquires the physical address in the second memory 320 and the progress value from the data arrangement information management table 224 (Step S992).

The controller processing unit 210 designate the physical address acquired in Step S992 and issues reading requests for the first memory 310 and the second memory 320 (Step S993). The data read from the first memory 310 is 264-byte data read from one physical page. The ECC processing unit 240 performs error correction and holds 256 bytes including only a data portion in the first memory verification buffer. The data read from the second memory 320 is data read from a physical page of the number of the progress value acquired in Step S922 and is held by the second memory verification buffer.

The controller processing unit 210 compares the data held by the first memory verification buffer with the data held by the second memory verification buffer (Step S994). The data length at this time is the length corresponding to the number of pages of the progress value acquired in Step S992. If it is assumed that the progress value is N, for example, the data is “N×2”-byte data.

The controller processing unit 210 determines whether or not data up to the progress value coincides in Step S994 (Step S995). In a case in which the data up to the progress value coincides (Step S995: Yes), the second memory data verification processing ends normally. Meanwhile, in a case in which the data up to the progress value does not coincide (Step S995: No), the controller processing unit 210 searches for “head logical address” that coincides the head logical address received as an input to the data arrangement information management table 224. Then, the controller processing unit 210 updates the corresponding “progress” value to “0” (Step S996).

In this manner, it is possible to omit rewriting of data in the second memory 320 in a case in which the data overwritten in the first memory 310 coincides with the data that has already been transferred to the second memory 320.

### [Second Modification Example]

In the aforementioned first modification example, data is read from the first memory 310 as processing performed when the data in the first memory 310 and the data in the second memory 320 are compared (Step S993). Meanwhile, a second modification example is adapted on the assumption that data received during execution of the writing command processing is utilized. That is, 256 bytes in the 512-byte data received by the memory controller 200 from the host computer 100 is held by the first memory verification buffer when the writing command processing is executed. Then, the held data and the data read from the second memory 320 are compared. In this manner, reading from the first memory 310 can be omitted.

### [Third Modification Example]

In the aforementioned first embodiment, the start of the data transfer processing is triggered by the issuance of the data transfer command from the host computer 100. Meanwhile, the third modification example is adapted on the assumption that a timer is provided inside the memory controller 200, and the start of the data transfer processing is triggered by the timer.

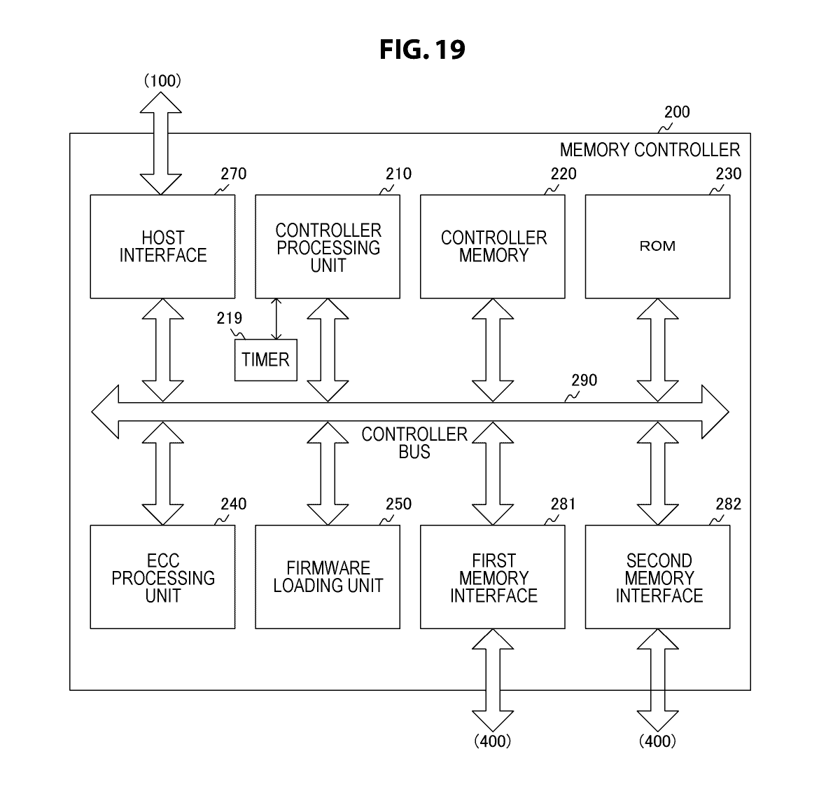

FIG. 19 is a diagram illustrating a configuration example of a memory controller 200 according to the third modification example of the first embodiment of the present technology. An elapse time from the end of the writing command or the reading command is counted by the timer 219, and in a case in which the writing command or the reading command has not been received for a predetermined period, the memory controller 200 starts the data transfer processing on the assumption that the idling period has continued. In this manner, it is possible to start the data transfer processing without waiting for the issuance of the data transfer command from the host computer 100.

### [Fourth Modification Example]

Although it is determined whether or not it is possible to perform the data transfer processing in accordance with whether or not there is a command received from the host computer 100 in the aforementioned first embodiment, a fourth modification example is adapted on the assumption that it is determined whether or not it is possible to perform the data transfer processing in accordance with whether or not there is data reading from the second memory 320 in the fourth modification example.

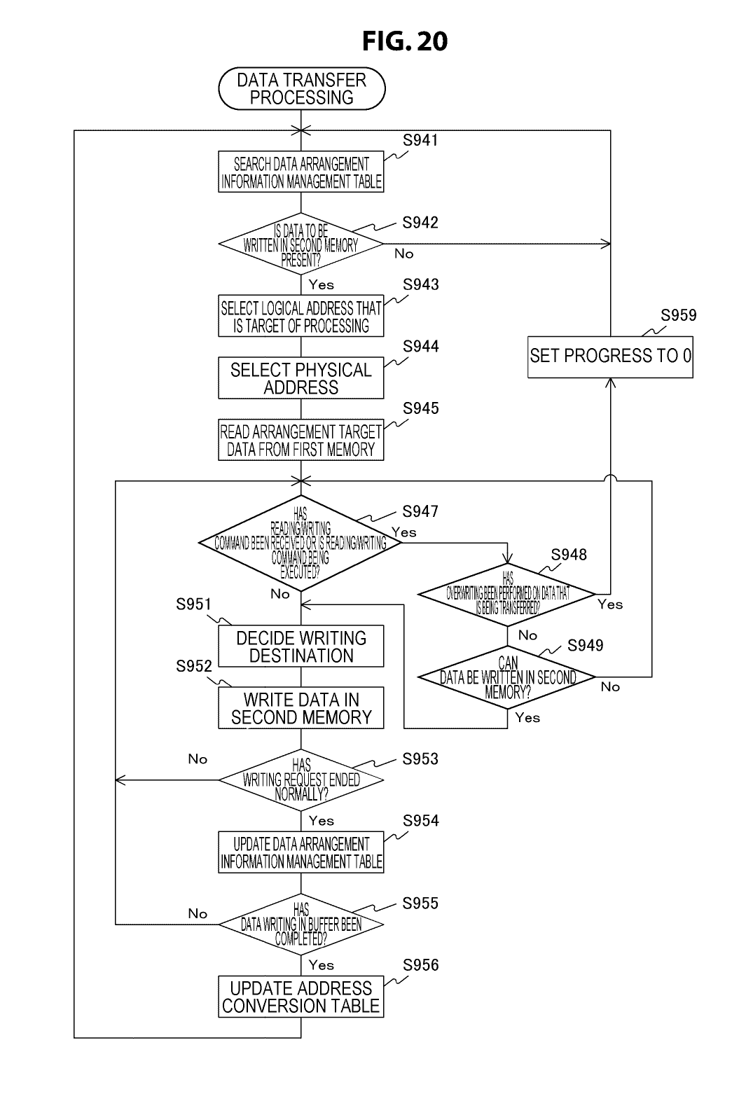

FIG. 20 is a flow diagram illustrating an example of a processing procedure for data transfer processing according to the fourth modification example of the first embodiment of the present technology. The data transfer processing according to the fourth modification example is different in that the processing in Steps S947 to S949 is performed instead of Step S946 in the first embodiment.

The controller processing unit 210 examines whether or not there is a reading command or a writing command received by the command execution task and whether or not there is a reading command or a writing command that is being executed by the command execution task, by the control task (Step S947). As a result, in a case in which there is a reading command or a writing command that has been received or is being executed (Step S947: Yes), it is determined whether writing (overwriting) has been performed on the logical address selected in Step S943 (Step S948). In a case in which overwriting has been performed (Step S948: Yes), the “progress” value in the data arrangement information management table 224 corresponding to the logical address selected in Step S943 is updated to “0” (Step S959), and the processing in Step S941 and the following steps is repeated.

Meanwhile, in a case in which overwriting has not been performed (Step S948: No), the controller processing unit 210 determines whether or not it is possible to perform writing in the second memory 320 (Step S949). In a case in which the command that has been received or is being executed in a writing command, for example, in the determination, and if the size of the unwritten data is equal to or greater than 1 Kbyte, it is possible to determine that the writing in the second memory 320 can be performed. Also, in a case in which the command that has been received or is being executed is a reading command, for example, and if the reading of the data of the head logical address is not a target of high-speed reading and the size of unread data is equal to or greater than 4 Kbytes, it is possible to determine that writing in the second memory 320 can be performed. Note that a case in which the reading of the data of the head logical address is a target of high-speed reading but the reading has been completed may also be included at this time.

In Step S949, an inquiry about a time required to perform writing or reading with respect to the first memory 310 is provided to the command execution task. It is assumed that the control task performs data writing on the assumption that no access to the second memory 320 occurs when the writing or the reading with respect to the first memory 310 is performed. In a case in which writing in two banks is performed in parallel in response to a writing command, that is, in a case in which writing is simultaneously performed on two physical pages, for example, the writing busy time of 1 Kbyte data is 10 seconds×2=20 seconds and is longer than the time for writing data one time in the second memory 320, which is 19.1 seconds. In addition, it is assumed that a reading request with respect to the second memory 320 does not occur for at least 20 seconds in the writing in the first memory 310. Meanwhile, it similarly takes 2.5 seconds×8=20 seconds to read 4 Kbytes in a case of a reading command, and it is assumed that a reading request with respect to the second memory 320 does not occur for at least 20 seconds in the reading from the first memory 310.

Note that the first to fourth modification examples described here can be similarly applied to the following second and third embodiments.

### 2. Second Embodiment

In the aforementioned first embodiment, the head logical address designated by the writing command is registered in the data arrangement information management table 224. Meanwhile, a head logical address designated by a reading command is registered in the data arrangement information management table 224 in a second embodiment. Note that since a basic configuration of an information processing system according to the second embodiment is similar to that in the aforementioned first embodiment, detailed description thereof will be omitted.

### [Operations of Information Processing System]

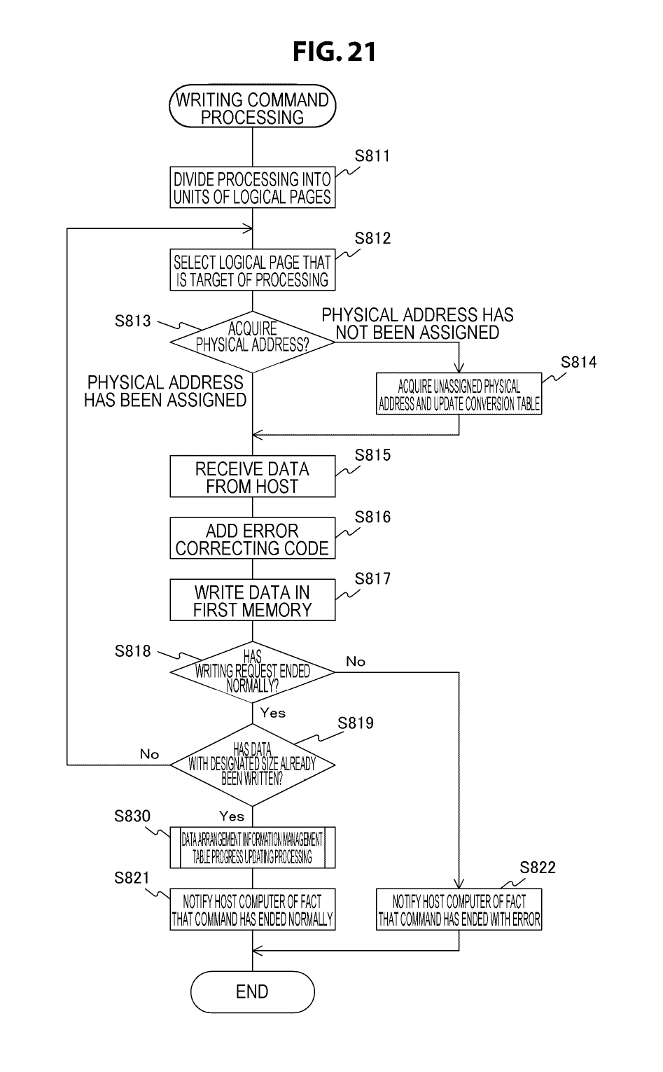

FIG. 21 is a flow diagram illustrating an example of a processing procedure for writing command processing according to the second embodiment of the present technology. The writing command processing according to the second embodiment is basically similar to that in the aforementioned first embodiment. That is, Steps S811 to S819, S821, and S822 in the second embodiment are similar to Steps S911 to S919, S921, and S922 in the first embodiment. Meanwhile, data arrangement information management table logical address updating processing (Step S830) in the second embodiment is different from that in the first embodiment as illustrated in the following diagram.

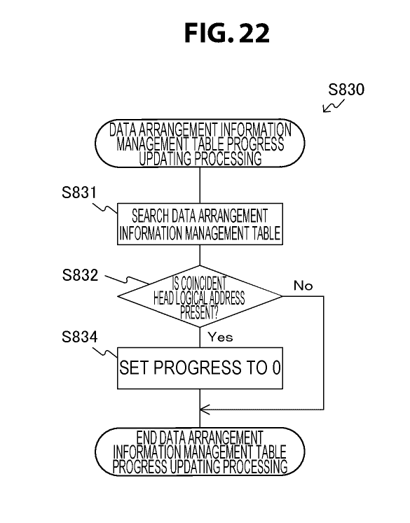

FIG. 22 is a flow diagram illustrating an example of a processing procedure for the data arrangement information management table logical address updating processing (Step S830) according to the second embodiment of the present technology. The data arrangement information management table logical address updating processing according to the second embodiment is basically similar to that in the aforementioned first embodiment. That is, Steps S831, S832, and S834 in the second embodiment is similar to Steps S931, S932, and S934 in the first embodiment. Meanwhile, the second embodiment is different in that Step S933 in the first embodiment is omitted. That is, the registration of “head logical address” in the data arrangement information management table 224 is not performed in the writing command processing in the second embodiment.

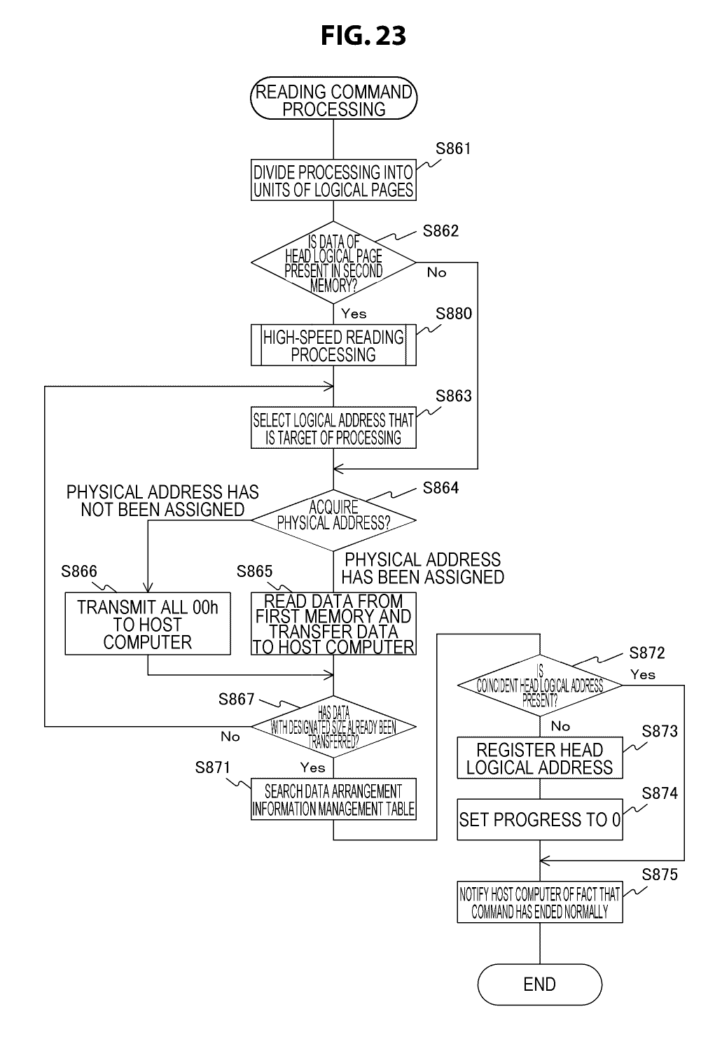

FIG. 23 is a flow diagram illustrating an example of a processing procedure for reading command processing according to the second embodiment of the present technology. The reading command processing according to the second embodiment is basically similar to the aforementioned first embodiment. That is, Steps S861 to S867, S875, and S880 in the second embodiment are similar to Steps S961 to S967, S975, and S980 in the first embodiment. Meanwhile, the second embodiment is different from the first embodiment in that processing in Steps S871 to S874 is performed.

The controller processing unit 210 searches for a logical address that coincides with the input logical address from “head logical address” in the data arrangement information management table 224 (Step S871). In a case in which the coincident “head logical address” is not present in the data arrangement information management table 224 (Step S872: No), it means that the logical address has not been registered in the data arrangement information management table 224. In that case, the controller processing unit 210 adds the input logical address to “head logical address” in the data arrangement information management table 224 (Step S873). In addition, the controller processing unit 210 updates the “progress” value corresponding to “head logical address” with which the input logical address coincides in the data arrangement information management table 224 to “0” (Step S874). This represents a state in which the data written in the first memory 310 by the writing command processing has not been transferred to the second memory 320.

According to the second embodiment of the present technology, it is possible to register the head logical address designated by the reading command in the data arrangement information management table 224 as described above.

### 3. Third Embodiment

The head logical address designated by the writing command is registered in the data arrangement information management table 224 in the aforementioned first embodiment, and the head logical address designated by the reading command is registered in the data arrangement information management table 224 in the second embodiment. Meanwhile, a third embodiment is adapted on the assumption that a logical address designated by a dedicated command (logical address registration command) is registered in the data arrangement information management table 224.

The host computer 100 notifies, by a logical address registration command, the storage device 400 of the logical address, from which data is read at a high seed in a case in which the logical address is designated as a head logical address by the reading command.

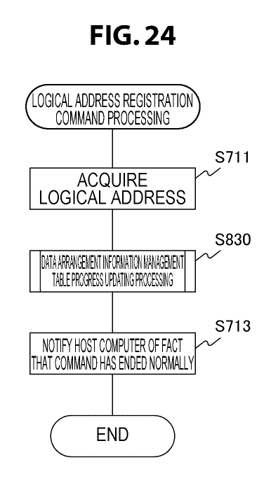

FIG. 24 is a flow diagram illustrating an example of a processing procedure for logical address registration command processing according to the third embodiment of the present technology. The logical address registration command processing is processing that is executed when the memory controller 200 receives a logical address registration command from the host computer 100. The following processing is executed in a command execution task.

The controller processing unit 210 acquires the logical address received in the logical address registration command (Step S711).

The controller processing unit 210 performs data arrangement information management table logical address updating processing by using the logical address acquired in Step S711 as an input. The data arrangement information management table logical address updating processing is similar to the data arrangement information management table logical address updating processing (Step S830) in the aforementioned second embodiment.

The controller processing unit 210 notifies the host computer 100 of the fact that the processing of the logical address registration command has ended (Step S713).

Note that in the third embodiment, the writing command processing is similar to that in the aforementioned second embodiment while the reading command progressing is similar to that in the aforementioned first embodiment. Therefore, detailed description will be omitted here.

### [Modification Example of Third Embodiment]

Although the host computer 100 designates the logical address value to which high-speed reading is applied with the dedicated command in the aforementioned third embodiment, a notification indicating that the high-speed reading is to be applied in specific units may be provided with a dedicated command. In a case in which the notification is provided with a dedicated command in units of 4 Kbytes, for example, the memory controller 200 arranges 256 bytes in the second memory 320 at every 4 Kbytes, such as arrangement of logical addresses at 0, 8, 16, and 20.

The above-described embodiments are examples for embodying the present technology, and matters in the embodiments each have a corresponding relationship with disclosure-specific matters in the claims. Likewise, the matters in the embodiments and the disclosure-specific matters in the claims denoted by the same names have a corresponding relationship with each other. However, the present technology is not limited to the embodiments, and various modifications of the embodiments may be embodied in the scope of the present technology without departing from the spirit of the present technology.

The processing sequences that are described in the embodiments described above may be handled as a method having a series of sequences or may be handled as a program for causing a computer to execute the series of sequences and recording medium storing the program. As the recording medium, a CD (Compact Disc), an MD (MiniDisc), and a DVD (Digital Versatile Disc), a memory card, and a Blu-ray disc (registered trademark) can be used.

Note that the effects described in the present specification are not necessarily limited, and any effect described in the present disclosure may be exhibited.

Additionally, the present technology may also be configured as below.

(1)

A memory control device including:

a writing unit that writes writing data related to a writing command in a first memory when the writing command is executed;

a transfer unit that transfers the writing data from the first memory to a second memory at a predetermined timing; and

a reading unit that performs reading of reading data from the second memory with higher priority than from the first memory when a reading command is executed.

(2)

The memory control device according to (1), in which the reading unit performs reading from the second memory in a case in which the reading data of the reading command is stored in the second memory and performs reading from the first memory in a case in which the reading data is not stored in the second memory.

(3)

The memory control device according to (1) or (2), in which the second memory has a lower writing speed than the first memory and has a higher reading speed than the first memory.

(4)

The memory control device according to any of (1) to (3), in which the transfer unit executes the transfer in response to issuance of a data transfer command.

(5)

The memory control device according to any of (1) to (3), further including:

a timer that times an idling period during which issuance of the writing command or the reading command is not received,

in which the transfer unit executes the transfer if the timer detects that the idling period has continued for a predetermined period.

(6)

The memory control device according to any of (1) to (3), in which the transfer unit executes the transfer in a period during which reading of data from the second memory does not occur.

(7)

The memory control device according to any of (1) to (6), further including: a progress information holding unit that holds progress information of the transfer, in which the transfer unit updates the progress information held by the progress information holding unit during execution of the transfer.

(8)

The memory control device according to (7), in which the transfer unit interrupts the transfer in response to issuance of another command during execution of the transfer, and restarts the transfer in accordance with the progress information after processing of the other command is completed.

(9)

The memory control device according to any of (1) to (8), in which, in a case in which overwriting occurs in the first memory due to another writing command after the writing data is transferred from the first memory to the second memory, the transfer unit regards the transfer as not having been performed.

(10)

The memory control device according to any of (1) to (8), in which, in a case in which overwriting occurs in the first memory due to another writing command after the writing data is transferred from the first memory to the second memory, the transfer unit compares the transferred writing data with writing data related to the other writing command, and the transfer unit transfers the writing data related to the other writing command from the first memory to the second memory only in a case in which the transferred writing data and the writing data related to the other writing command are different from each other.

(11)

The memory control device according to any of (1) to (10), in which the transfer unit selects data to be transferred from the first memory to the second memory on a basis of an address related to the writing command.

(12)

The memory control device according to any of (1) to (10), in which the transfer unit selects data to be transferred from the first memory to the second memory on a basis of an address related to the reading command.

(13)

The memory control device according to any of (1) to (10), in which the transfer unit selects data to be transferred from the first memory to the second memory on a basis of an address designated by another command that is different from the writing command and the reading command.

(14)

A storage device including:

a first memory;

a second memory that has a lower writing speed and a higher reading speed than the first memory;

a writing unit that writes writing data related to a writing command in the first memory when the writing command is executed;

a transfer unit that transfers the writing data from the first memory to the second memory at a predetermined timing; and

a reading unit that performs reading of reading data from the second memory with higher priority than from the first memory when a reading command is executed.

(15)

An information processing system including:

a first memory;

a second memory that has a lower writing speed and a higher reading speed than the first memory;

a host computer that issues a command related to the first memory or the second memory;

a writing unit that writes writing data related to a writing command in the first memory when the writing command is executed;

a transfer unit that transfers the writing data from the first memory to the second memory at a predetermined timing; and

a reading unit that performs reading of reading data from the second memory with higher priority than from the first memory when a reading command is executed.

### REFERENCE SIGNS LIST

100 host computer
101 application program
102 host OS
103 device driver
110 host processing unit
120 host memory
170 controller interface
190 host bus
200 memory controller
210 controller processing unit
219 timer
220 controller memory
221 address conversion table
222 unassigned physical page information
223 transfer buffer
224 data arrangement information management table
230 ROM
240 ECC processing unit
250 firmware loading unit
270 host interface
281 first memory interface
282 second memory interface
290 controller bus
310 first memory
311, 312 memory cell array
320 second memory
321, 322 memory cell array control unit
331, 332 address decoder
341, 342 data buffer
370 controller interface
390 memory bus
400 storage device

1. A memory control device comprising:
a writing unit that writes writing data related to a writing command in a first memory when the writing command is executed;
a transfer unit that transfers the writing data from the first memory to a second memory at a predetermined timing; and
a reading unit that performs reading of reading data from the second memory with higher priority than from the first memory when a reading command is executed.

2. The memory control device according to claim 1, wherein the reading unit performs reading from the second memory in a case in which the reading data of the reading command is stored in the second memory and performs reading from the first memory in a case in which the reading data is not stored in the second memory.

3. The memory control device according to claim 1, wherein the second memory has a lower writing speed than the first memory and has a higher reading speed than the first memory.

4. The memory control device according to claim 1, wherein the transfer unit executes the transfer in response to issuance of a data transfer command.

5. The memory control device according to claim 1, further comprising:
a timer that times an idling period during which issuance of the writing command or the reading command is not received,
wherein the transfer unit executes the transfer if the timer detects that the idling period has continued for a predetermined period.

6. The memory control device according to claim 1, wherein the transfer unit executes the transfer in a period during which reading of data from the second memory does not occur.

7. The memory control device according to claim 1, further comprising:
a progress information holding unit that holds progress information of the transfer,
wherein the transfer unit updates the progress information held by the progress information holding unit during execution of the transfer.

8. The memory control device according to claim 7, wherein the transfer unit interrupts the transfer in response to issuance of another command during execution of the transfer, and restarts the transfer in accordance with the progress information after processing of the other command is completed.

9. The memory control device according to claim 1, wherein, in a case in which overwriting occurs in the first memory due to another writing command after the writing data is transferred from the first memory to the second memory, the transfer unit regards the transfer as not having been performed.

10. The memory control device according to claim 1, wherein, in a case in which overwriting occurs in the first memory due to another writing command after the writing data is transferred from the first memory to the second memory, the transfer unit compares the transferred writing data with writing data related to the other writing command, and the transfer unit transfers the writing data related to the other writing command from the first memory to the second memory only in a case in which the transferred writing data and the writing data related to the other writing command are different from each other.

11. The memory control device according to claim 1, wherein the transfer unit selects data to be transferred from the first memory to the second memory on a basis of an address related to the writing command.

12. The memory control device according to claim 1, wherein the transfer unit selects data to be transferred from the first memory to the second memory on a basis of an address related to the reading command.

13. The memory control device according to claim 1, wherein the transfer unit selects data to be transferred from the first memory to the second memory on a basis of an address designated by another command that is different from the writing command and the reading command.

14. A storage device comprising:
a first memory;
a second memory that has a lower writing speed and a higher reading speed than the first memory;
a writing unit that writes writing data related to a writing command in the first memory when the writing command is executed;
a transfer unit that transfers the writing data from the first memory to the second memory at a predetermined timing; and
a reading unit that performs reading of reading data from the second memory with higher priority than from the first memory when a reading command is executed.

15. An information processing system comprising:
a first memory;
a second memory that has a lower writing speed and a higher reading speed than the first memory;
a host computer that issues a command related to the first memory or the second memory;
a writing unit that writes writing data related to a writing command in the first memory when the writing command is executed;
a transfer unit that transfers the writing data from the first memory to the second memory at a predetermined timing; and
a reading unit that performs reading of reading data from the second memory with higher priority than from the first memory when a reading command is executed.
